(19) United States
(12) Patent Application Publication
(10) Pub. No.: US 2017/0352282 A1
(43) Pub. Date: Dec. 7, 2017

(54) IMAGE-BASED FEEDBACK FOR ASSEMBLY INSTRUCTIONS

(71) Applicant: International Business Machines Corporation, Armonk, NY (US)

(72) Inventors: Evelyn R. Anderson, Houston, TX (US); Michael Bender, Rye Brook, NY (US); Rhonda L. Childress, Austin, TX (US)

(21) Appl. No.: 15/172,235

(22) Filed: Jun. 3, 2016

(51) Int. Cl. G09B 5/02; G06T 7/00; G06T 7/20; H04N 5/247

(52) U.S. Cl. CPC G09B 5/02; H04N 5/247; G06T 7/0012; G06T 7/20; G06T 2207/30164

(57) ABSTRACT

A set of images of a product are obtained from a camera. The set of images are of a plurality of parts of the product being assembled. Based on the set of obtained images, an assembly step that is being performed is detected. One or more assembly metrics for assembling the product are retrieved. A potential assembly issue is determined. The determination is based on the detected assembly step and also based on the retrieved assembly metrics. An assistance feedback is provided based on the determined potential assembly issue.

### BACKGROUND

The present disclosure relates to assembly instructions, and more specifically, to utilizing image-recognition to provide improvements to instructions for assembling products. The movement of a user throughout a real-world environment may be tracked to determine more information about the user and the environment. This tracking may allow a computer system to determine both past actions but also make decisions about the environment in real-time or near-time (e.g., the present). The ability for a computer to track the movement, position, and relationship to other objects may be beneficial in an assembly scenario. The assembly of products may occur in a consumer setting whereby end-users may assembly household products (e.g., furniture, children's toys, etc.). The assembly of products may occur in a manufacturing setting whereby humans work on an assembly line. The assembly of products may occur in commercial settings, such as the installation of a one product into an environment (e.g., a service technician may install a computer server into a data center).

### SUMMARY

Disclosed herein are embodiments of a method and computer program product for aiding assembly of a product, the product includes a plurality of parts. A set of images of the product are obtained from a camera. The set of images are of the plurality of parts being assembled. Based on the set of obtained images, an assembly step that is being performed is detected. One or more assembly metrics for assembling the product are retrieved. A potential assembly issue is determined. The determination is based on the detected assembly step and also based on the retrieved assembly metrics. An assistance feedback is provided based on the determined potential assembly issue.

Also disclosed herein are embodiments of a system for aiding assembly of a product, the product includes a plurality of parts. The system includes a camera communicatively coupled to a processor. The camera captures one or more images of the product. A processor obtains a set of images from the camera. The set of images are of the plurality of parts being assembled. Based on the set of obtained images, an assembly step that is being performed is detected by the processor. One or more assembly metrics for assembling the product are retrieved by the processor. A potential assembly issue is determined by the processor. The determination is based on the detected assembly step and also based on the retrieved assembly metrics. An assistance feedback is provided by the processor and based on the determined potential assembly issue.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example method for using images to determine an issue with an assembly of a product by a user in accordance with embodiments of the present disclosure.

FIG. 2 depicts an example method for performing corrected actions to assembly instructions based on assembly issues experienced by a user in accordance with embodiments of the present disclosure.

FIG. 3 depicts an example environment of a computing device being used to provide assembly instructions and a feedback loop to assist a user with assembly of a product in accordance with embodiments of the present disclosure.

FIG. 4 depicts the representative major components of an example computer system 401 that may be used in accordance with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to assembly instructions, more particular aspects relate to utilizing image-recognition to provide improvements to instructions for assembling products. While the present disclosure is not necessarily limited to such applications, various aspects of the disclosure may be appreciated through a discussion of various examples using this context.

In certain situations, products may be created through the assembly of parts. For example, a piece of furniture in a home may be a product and a consumer (user) may purchase the furniture from a retail store. The furniture may be provided as parts for shipping, such as pieces material (e.g., wood, glass, etc.) as well as fasteners (e.g., screws, dowels, adhesive glues, etc.). To aid in assembly of the product a provider of the product may include instructions. The instructions may be logically arranged into a series of written steps, or may be in the form of pictorial depictions. In a second example, employees of a large company may assemble products of various complexities in a manufacturing setting (e.g., an automobile company may assembly passenger cars and trucks for sale to customers). The large company may provide instructions to the employees for use during assembly. The quality of the instructions provided to the users ensure that the assembly is accurate, efficient, and repeatable.

Product providers (providers) may provide guidance to users through the instructions. The instructions are often static representations of the ideal way the assembly of the parts should go. The instructions may sometimes provide additional information to users in case of confusion or difficulty in following the instructions. For example, the instructions may include a telephone number or an email address for the user to contact the provider and schedule an appointment for getting clarification regarding specific steps or to determine if none of the parts are missing. Additionally and in some circumstances, users may search the Internet for assistance in assembling the product. For example, a user may use a search engine to find the providers website or to find a forum where other users have solved any issues they may have encountered with the assembly of the product.

Providers may also seek to improve their instructions for future users through a variety of sources. The providers may employ customer service agents to record information from telephone or online discussions that a provider and a user have regarding issues with the instructions. In some situations, the providers may directly record the discussions with users. The providers may also send out feedback requests, in the form of surveys to the users that have purchased the products to solicit clarification about the good and bad experiences with the assembly of the products and the quality and helpfulness of the instructions. In some circumstances, the providers may hire quality assurances representatives (QA reps) to help devise the instructions. The QA reps may repeatedly perform assembly of the products before during and after the product's release, to ensure that the instructions are adequate.

In some embodiments of the present disclosure, an image-based feedback loop (IFL) may be used to improve the experience of assembling products with instructions. The IFL may improve the assembly process by identifying the item to be assembled. The IFL may identify the current step that the user is performing to pinpoint where help is needed. The IFL may identify improper assembly of the device or other assembly issues. The IFL may also identify improper repair or maintenance (e.g., a professional mechanic removes five lug-nuts and the IFL notifies the mechanic if not all five lug-nuts are replaced). The IFL may provide enhanced instructions (e.g., audio or video instructions of how to perform the assembly). The IFL may provide helpful supplemental information to the instructions to aid the understanding of the instructions and the assembly process (e.g., links to social networking, or experienced professional assemblers).

In some embodiments, the IFL may be used to detect deficiencies in instructions. The IFL may analyze the assembly issues and may determine based on the analyzed issues particular steps that have inadequate instructions. The analysis may take into account a few number of assembly issues with a particular step. The analysis may take into account an increased number of assembly issues with a particular step. The identified deficiencies in one or more steps of the assembly instruction may cause the IFL to perform a corrective action such as notifying a provider of the product to update the steps of the instructions.

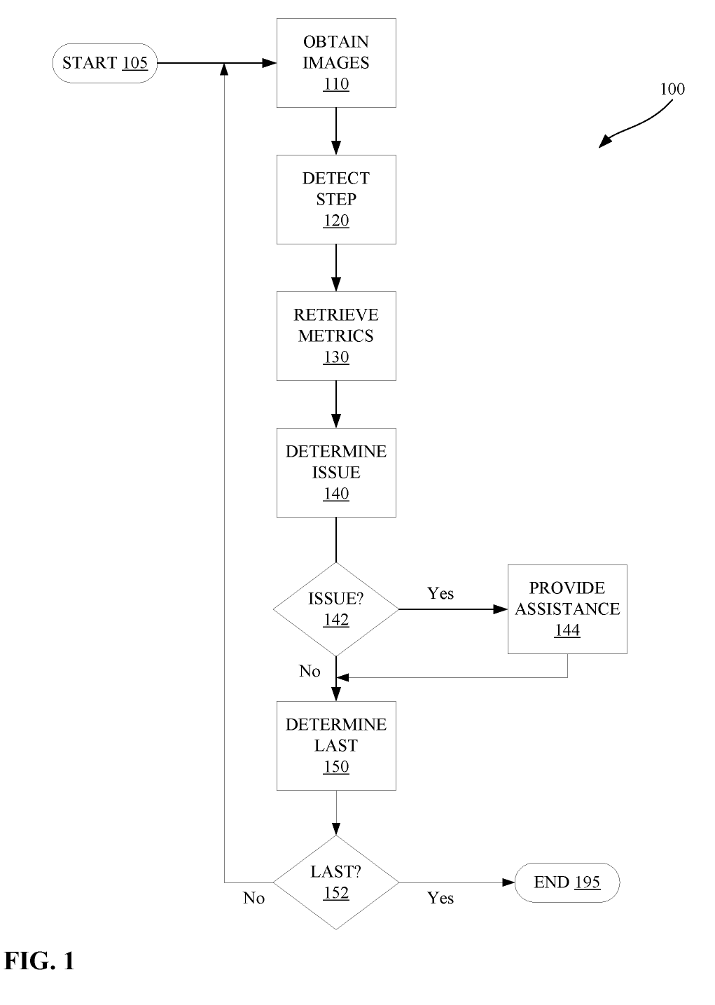

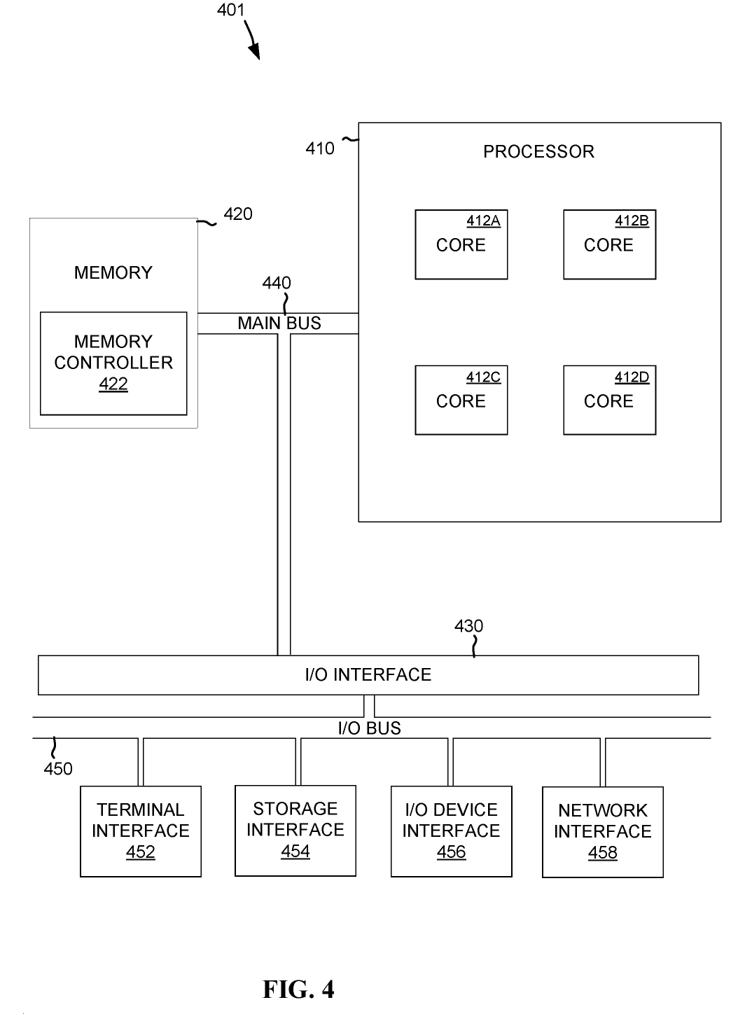

FIG. 1 depicts an example method 100 for using images to determine an issue with an assembly of a product by a user in accordance with embodiments of the present disclosure. Method 100 may be performed by a computing device of the user. The computing device may be a portable device such as a smart-phone, augmented-reality headset, or portable camera. In some embodiments, one or more operations of method 100 may be performed on a server communicatively coupled to the computing device. The computing device, the server, or both may include one or more components of a computer (e.g., the computer 401 of FIG. 4) that may perform the operations of method 100. Method 100 may include more or less operations than those depicted and, in some embodiments, certain operations may be combined or separated. The operations of method 100 may be performed continuously (e.g., every 100 milliseconds, every sixteen milliseconds, etc.).

From start 105, one or more images may be obtained at 110. The images may be obtained, at 110, through a camera integrally coupled to the computing device (e.g., a camera built into a smart-phone). The images may be obtained, at 110, from a camera communicatively coupled to the computing device (e.g., a portable camera with a wireless antenna in communication with a desktop computer). In some embodiments, the images may be obtained, at 110, from a plurality of cameras. For example, a portable camera with Bluetooth™ capability may be set on a tripod and oriented to capture a real-world scene from a first perspective of a user assembling a bookshelf. The user may utilize a smart-phone with an integrated phone-camera to wirelessly connect to the portable camera and capture images from the portable camera. The user may place her smartphone on a phone-stand and the smartphone may begin to capture additional images from the phone-camera from a second perspective.

The computing device may detect the performance of an assembly step at 120. The step may be detected, at 120, through one or more object detection techniques. The detection, at 120, may utilize an appearance-based technique to match one or more obtained images to one or more example images accessible to the computing device (e.g., accessible from local storage on the computing device or in a data-store on a network accessible by the computing device). The detection, at 120, may utilize a feature-based technique to hypothesize the objects contained in one or more obtained images by comparing objects in the images to a previously understood collection of objects. The previously understood collection of objects may be influenced by the user of the computing device. For example the user may utilize a graphical user interface (GUI) on a smartphone to select a product from a provider's phone application (app). The app may contain a listing for the product as well as installation instructions. By accessing the installation instructions the computing device may make more intelligent hypotheses about captured images based on the type of objects that are likely to be captured by the computing device given the product being installed. The hypothesized objects may include the following: parts of the product; the product in a partially assembled state; household items that would be utilized near or with the product after it is fully assembled; tools that may be utilized to assemble the product; and packaging that may be utilized to ship the product before assembly.

In some embodiments, the detection of the performance of the assembly step, at 120, may be a series of processes to the one or more images that were obtained, at 110. In detail, a computer system may take the obtained images and apply one or more object detection algorithms to determine one or more objects within the obtained images (e.g., a person, a product, a part, etc.). The object detection algorithm may be edge detection and may be performed by taking the raw values of one or more pixels and comparing those values to adjacent pixels surrounding the one or more pixels. The comparison may be able to determine the difference between an edge through the differences in the values of the pixels (e.g., the color, the brightness, the contrast, etc.). For example, a first edge may highlight a difference in values between two adjacent pixels that is greater than those of other adjacent pixels (e.g., a discontinuity in depth, a discontinuity in surface orientation, a variance in scene illumination, etc.). By looping through all pixels and performing the comparison on each pixel of one image of the obtained images, a series of connected curves (e.g., boundaries) of objects within the one image may be identified. Another object detection algorithm may be background subtraction against a series of images. In background subtraction, given a stationary camera the computer may detect fluctuating pixel values across subsequent obtained images. The pixel values that fluctuate may correspond to a moving object (an identifiable object) against non-fluctuating pixels (contrasting a stationary background).

The next process may be one or more image correction algorithms. An image correction algorithm may be color correction to adjust the color or brightness of the image, captured from the camera, to account for the specific conditions of the environment where the obtained images were captured. For example, the lighting inside an environment may be poor and the poor lighting may be determined because during the object detection process a low number of objects (or no objects) may be detected. Continuing the example if poor lighting is detected, then the pixels may be adjusted by increasing red, green, and blue values of each pixel of the images. Further continuing the example, after the color correction is applied, the object detection process may be repeated. Another image correction algorithm may be optical correction. The optical correction may utilize information about the device that captured the images (e.g., the shape of the lenses, the focal length, the number of lenses, etc.). The optical correction may apply a correction factor (e.g., a set of one or more values) to the obtained image to provide an undistorted view of the environment captured by the camera. For example, a correction factor may be to adjust the outermost ring of pixels by a first value. Continuing the example, the correction factor may be to adjust the next outermost ring (just inside the outermost ring) of pixels by a second value. Further continuing the example, the correction factor may be mapped to a table, and matrix math may be applied to adjust each of the pixels by the proper values to enact the optical correction onto the obtained image. The correction factor may be specific to the camera that obtained the image and may be retrieved from a database of camera correction factors. In some embodiments, the image correction algorithms may be applied before the object detection algorithms.

The next process for determining the assembly step, at 120, may be an object determination and calculation technique. In detail, each product (and the corresponding parts of the product) may be stored in a database of the product provider. The edges detected in the images may be analyzed for geometric shapes (e.g., straight lines, curves, vertexes where two lines meet, etc.). The edges may additionally be analyzed for depth, such as by factoring in relative shading and brightness—a brighter section may indicate a surface closer to the camera than a darker section. Continuous sections where brightness or texturing of adjacent pixels may indicate a continuous surface. These patterns within the image may be matched against each part of the product in the database of the product provider for a most likely part match. This may be repeated for each edge within a given image. This may result in multiple parts that fall within a given image being determined. The process of comparison may be repeated on subsequent images to increase the confidence level that an edge corresponds to a part.

The determination and calculation technique may further include photogrammetry methods. Herein photogrammetry may be understood as the science of taking measurements from images. The input of photogrammetric methods may be the one or more images (e.g., still frames or video footage) of a real-world object of interest obtained, at 110. The real-world object may be identified from the edges and continuous curves that were identified in the previous process of edge detection. The edges may be analyzed collectively to determine the real-world object in the image. For example, three edges may be detected in a first image. The three edges in the image may meet at a single point. The three edges may be rendered as a 3D model. The features of the model may be utilized to identify the part. The features may include not only the length of the individual edges of the model but also the relationship between them. For each detected edge, pixels along the direction of the edge may be counted. The pixel counts of the detected edges can be compared to each other. The compared edges may be expressed mathematically as ratios that may be used to compare against 3D models of parts that are in the product provider's database. The corresponding output of the photogrammetric methods may include a computer-rendered measurement, image, or three-dimensional (3D) model of that real-world object. The detection, at 120, may include the size, shape, and orientation of one or more parts.

The photogrammetry algorithm may further allow for determining from the output additional data about other real-world objects with which the part of the product may be associated. The detection, at 120, may also include an assembly movement of the user (e.g., that a user is attempting to utilize a hammer to drive a nail to fasten a first part to a second part of a product; that a user is attempting to insert a first part along a first direction into a second part of a product; etc.). The determination and calculation techniques may also use photogrammetry to measure the relative size and shape of the objects against constants (e.g., one part against another, one part against the box the product came in, the tools against the parts, etc.). In detail, once a part is identified by the computing device, data regarding the part may be used (e.g., the length of a side of the part in inches, the radius of a part, the diameter of a part, the thickness of a cross-section of a part, etc.). The data of the part may be retrieved from one or more databases of the product provider. The other edges and objects within the obtained image may then be compared to the edges of the identified part. The size, shape, and orientation of the other objects may then be derived and matched against other known constants (e.g., tools, humans, rooms in a home, etc.).

The computing device may retrieve one or more metrics that are related to the assembly of the product (assembly metrics) at 130. The assembly metrics may relate to the identification of a product that is being assembled by a user. The product may be identified through a user selection of a product in a GUI provided to the user by the computing device. The product may be identified from the images that were obtained, at 110, from a camera coupled to the computing device. The assembly metrics may encompass only the assembly step that was detected, at 120. In some embodiments, the assembly metrics may encompass assembly steps that are related to the assembly step that was detected, at 120. For example, a user may be assembling a table and the table may include five assembly steps. If it is determined that the user is performing the third assembly step, then metrics related to the second and third assembly steps may be retrieved.

The assembly metrics may be retrieved, at 130, from a local storage of the computing device (e.g., assembly metrics for a second assembly step may be retrieved from a flash storage of a smart-phone that contains assembly metrics for each step of assembly of a chair). The assembly metrics may be retrieved, at 130, from a remote data store that is communicatively accessible by the to the computing device, (e.g., a tablet retrieving assembly metrics for a manufacturing worker from a desktop computer through a local area network of a factory; a mother building a television stand may use a desktop computer application to assist in assembly and the desktop computer may retrieve metrics for all steps from the Internet; etc.).

The assembly metrics may include one or more features and rules related to performance of an assembly step or generally to the assembly of a product. The assembly metrics may relate to the proper manner in which to perform an assembly step, such as to lower a first part onto a second part. The assembly metrics may also relate to more optimal methods to perform the assembly. In certain situations, for example, the assembly metrics may indicate that turn a first part perpendicular to a second part and pass through a third part before rotating the first part parallel to the second part. The assembly metrics may relate to one or more partially assembled parts of a product. For example, a product chair may have parts as follows: a plurality of fasteners, four legs, two leg supports, one seat, and a backrest. The assembly metrics may dictate that the partially assembled chair should have the four legs connected to the base but not attached by any of the plurality of fasteners such that the legs are still partially moveable to receive the leg supports before being fixed by the fasteners.

The assembly metrics may identify a tool or tools that might be needed for assembly of the product. For example, the assembly metrics might dictate that a socket-wrench and a 10-mm socket are needed to install a windshield wiper on an automobile. The assembly metrics may relate to the identification of a proper technique that should be used, such as to combine a first part with a second part a wrench is needed. The assembly metrics may relate to how far parts need to move to assemble a product (e.g., moving a seat three feet to clear the base of a partially assembled chair). The assembly metrics may dictate measurements that must be followed for assembly, such as the torque specs for a bolt that attaches two parts together. In some embodiments, the assembly metrics may indicate the number of users suggested for assembly, such as two adults needed to properly lift a table-top part. The assembly metrics may dictate the time it may take an average user to perform the assembly step (e.g., a person should take no more than fifteen minutes to perform the assembly step, the average person takes eight minutes to perform the assembly step, etc.).

The computing device may determine there is an issue (a potential problem) with the assembly of the product at 140. The determination, at 140, may be based on the assembly metrics retrieved, at 130. The determination, at 140, may be based on the detected assembly step, at 120. The determination, at 140, may be based on the obtained images, at 110. The determination, at 140, may be based on a set of heuristics or rules. The issue determination, at 140, may be performed by comparing the detected assembly step and captured images to the assembly metrics. The comparison may utilize photogrammetry, or other methods of detecting objects within images. The determination, at 140, may be performed by comparing the detected objects in the captured images to the assembly metrics. For example, a third assembly step may be performed incorrectly by a user. A table-top part of a partially assembled table product may be in a horizontal position with a table-leg part fastened facing downward. The assembly metrics for the third assembly step may indicate that the table should be oriented vertically against a wall and may also indicate that the table-leg part should be fasted facing upward. The determination may detect both issues with the third assembly step.

The determination, at 140, may include a series of comparisons and decisions. The computing device is configured to perform a method, wherein, an image or multiple images of the assemblage of the parts compares the assemblage in its current state to a database of the assemblage in different states. The database is composed of one or more products assembly stages, and is keyed off of a product identifier. Upon identifying a deviation in the assemblage in the current state to that of the states in the database, the method identifies this as a defect. One skilled in the art of comparing images will be able to compare the images. The computing device may rank the comparisons to determine the step that has an issue (e.g., it is most likely that the user is failing to perform the second step). The computing device may also use previous executions and results of method 100 to determine the issue (e.g., a previous run through may have identified that the user was at step one and had completed it successfully so the computing device would rank higher the second step).

The determined issue may include that a user is improperly assembling two parts. The determined issue may include that a user is utilizing an improper tool (e.g., a cross-shaped screwdriver to turn a flat-shaped screw). The determined issue may include that a user is attempting to perform an assembly step on his own whereas it is recommended that the user perform the assembly step with the help of an additional user. The determined issue may include that a user is taking more time than an average user would take to perform the assembly step. In some embodiments, the determined issue may be that a user is taking more time than a threshold amount of time. For example, an assembly metric may be that a user should be able to perform the assembly step in ten minutes. Continuing the example, the threshold may be that a given assembly step should not take longer than forty-five percent longer than the assembly metric (e.g., a user that takes fifteen minutes to perform the assembly step would yield a determined issue).

If there is a determined issue, at 142, the computing device may provide assistance feedback at 144. The provided assistance feedback, at 144, may be one or more help scenarios that are likely to enable the user to understand the assembly step and to complete the assembly step. The help may be modifying one or more of the directions to provide natural feedback to the user. The modified directions may include highlighting various parts in a different color. The modified directions may include overlaying a shape, such as a circle, around a depicted part to emphasize to the user that the circled part was not used by the user. The modified directions may include animated depictions (e.g., flashing words of the directions, slowly growing or enlarging parts in relation to others that are static, etc.). In some embodiments, the modified directions may be in a different form of presentation. For example, if a user is provided with text directions, then the modified directions may be a prerecorded video version of the directions that the user may watch. In a second example, if the user if provided with pictorial directions, then the modified directions may be a series of step-by-step audio directions.

The help may be connecting the user to a support person that may assist the user. The support person may be an expert that is trained in both the assembly of the product and in teaching users to perform assembly steps. The user may be able to discuss the assembly with the support person and ask questions regarding the proper way to perform the assembly step. The help may be in the form of links to additional information related to the product (e.g., a hyperlink to additional product assembly directions located on the Internet). In some embodiments, the help may be in the form of connecting the user to a social media site. The social media site may include articles, videos, pictures, and other forms of additional help. The social media site may also enable the user to interact with other users related to the product (e.g., product experts, employees of the product provider, other users that have purchased and successfully performed the assembly steps, etc.). The social media site may enable the user to publicly post the images obtained by the computing device, at 110. In some embodiments, the computing device may provide to the user a subset of the images that were used to determine the issue, at 140.

After assistance feedback is provided at 144 (or if there was not issue determined at 142) the computing device determines if the detected assembly step is the last step at 150. Determining the last step, at 150, may include comparing the obtained images and detected steps to the retrieved metrics. Determining the last step, at 150, may be based on similar object detection and comparison techniques to that of determining if there is an issue.

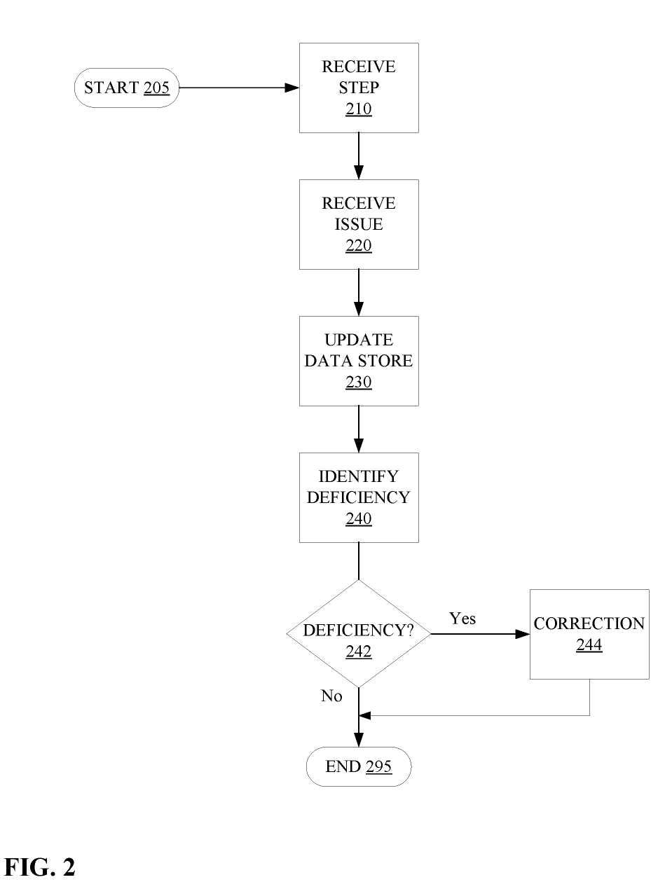

FIG. 2 depicts an example method 200 for performing corrected actions to assembly instructions based on assembly issues experienced by a user in accordance with embodiments of the present disclosure. In some embodiments, one or more operations of method 200 may be performed by a computing device of the user. The computing device may be a portable device such as a smart-phone, augmented-reality headset, or portable camera. In some embodiments, one or more operations of method 200 may be performed on a server communicatively coupled to the computing device. The computing device, the server, or both may include one or more components of a computer (e.g., the computer 401 of FIG. 4) that may perform the operations of method 200. Method 200 may include more or less operations than those depicted and, in some embodiments, certain operations may be combined or separated. The operations of method 200 may be performed continuously (e.g., every 100 milliseconds, every sixteen milliseconds, etc.).

From start 205, a detected assembly step may be received at 210. The received assembly step may have been detected by a portable computing device and may have been sent by the portable computing device to a server. The server may be owned by a product provider and may execute additional programs, such as management software or an email server. The received assembly step may be an optically derived assembly step (e.g., a step that was derived from a camera coupled to a computing device and detected through a photogrammetry technique). The received assembly step may also include one or more images that were obtained and utilized to detect the received assembly step.

The received assembly step may correspond to one or more actions that a user was attempting to perform in furtherance of assembling a computing device. The received assembly step may be indicative of a single assembly step. In some embodiments, a plurality of assembly steps may be received (e.g., if a user is performing a first assembly step the user may be nearly complete with the first assembly step, then the first assembly step and the second assembly step may be identified and received).

The received assembly step may be in a format that identifies the product to be assembled (e.g., product “14-235 End-Table”). The received assembly step may include additional values that identify additional elements of the assembly step (e.g., a list of parts that were detected in one or more obtained images of the assembly step, one or more users attempting to perform the assembly step, etc.). The received assembly step may be in the form of an assembly step record. An example of a received assembly step record is provided in the following Table 1:

TABLE 1

| | | Assembly | Identified | Identified |
|---|---|---|---|---|
| Product ID: | Categories: | Step: | Parts: | Tools: |
| 157-2 | Youth, Outdoors, | 3 | 2, 3, 7-9 | Screwdriver, |
| | Furniture | | | Socket-wrench, |
| | | | | Adhesive Glue |

Using the above Table 1, the product identification number in a database of the product provider may be “157-2.” The received assembly step may relate to an outdoor product designed to facilitate exercise for children (e.g., a swing-set, jungle-gym, slide, seesaw, combinations thereof, etc.). The received assembly step may have been identified to be the third assembly step. The assembly step may include the second, third, seventh, eighth, and ninth parts of the product. The assembly step may include the use of the following tools: screwdriver, socket-wrench, and an included adhesive.

A determined assembly issue may be received by the server at 220. The received assembly issue may be related to the assembly step such as a reference or identifier that indicates an association to the received assembly step (e.g., assembly issue regarding product “123-42B” kitchen table, assembly issue related to assembly step three of product aquarium, etc.). The received assembly issue may be of a category of problem (type of issue) that was encountered by the user (e.g., a long time taken to complete an assembly step, the assembly step was never completed, a user used a wrong tool, a user performed a first step after performing a second step, a user did not utilize all fasteners, etc.). The received assembly issue may relate to a solution (assistance feedback) that was provided to the user (e.g., user given expert help through video-conference, user given additional instructions through audible prompts, user linked to social networking Internet website, etc.). The received assembly issued may be in the form of an assembly issue record. An example of a received assembly issue record is provided in the following Table 2:

TABLE 2

| | Assembly | | |
|---|---|---|---|
| Product ID: | Step: | Issue Type: | Assistance Feedback: |
| 337-28 | 3 | Improper Completion | Expert Video |
| | | | Conference |

Using the above Table 1, the assembly issue record may contain the product identifier “337-28” that corresponds to a do-it-yourself desktop-computer (DIY PC). The assembly issue of the DIY PC may be the third step—insertion of memory into the DIY PC. The type of issue may be that the user was trying to insert a memory module into the DIY PC in an improper orientation. The assistance feedback provided to the user may have been to initiate an audio-visual communication session with an employee of the product provider that has experience assembling DIY PCs.

The received records may be updated into a data store at 230. The data store may be communicatively coupled to the servers that perform method 100. The data store may be one or more databases that are under control of the product producer. The database may contain one or more assembly records that include information about the assembly of the product (e.g., an inventory database with the number of products sold, a customer service database with the number of products successfully assembled, etc.). The database may contain one or more assembly records that include information about issues that occur during assembly of the product (e.g., the number of issues, the number of issues relating to a particular step, etc.). The data store may be updated, at 230, with some or all of the received assembly step, at 210. The data store may be updated, at 230, with some or all of the received assembly issue, at 220.

A deficiency in one or more assembly instructions of a product may be identified at 240. The assembly instruction deficiency may be identified, at 240, based on the received assembly issue, at 220. The deficiency in the assembly instructions may be identified, at 240, based on the updated data store, at 230. In some embodiments, the deficiency in assembly instruction may be identified, at 240, based on the received assembly step, at 210. The deficiency may be identified, at 240, by analyzing the updated data store.

The analysis may be based on a magnitude of products in the data store. For example, if a particular product has over a certain number of sales to users, then any assembly step issue that is received may cause an instruction deficiency to be identified. The analysis may be based on the magnitude of assembly issues in the data store (e.g., a particular product has a total of 500 assembly issues and the received assembly issue is related to the particular product). The analysis may be based on the number of assembly issues related to a given assembly step of a particular product. For example, a particular product has assembly issue entries as follows: step one has 125 entries, step three has 200 entries, and step eight has 178 entries. Continuing the example, the analysis may be that if an assembly issue is received for the third step, a deficiency in the assembly instructions may be identified. Further continuing the example, the deficiency in the assembly instructions may be identified because there are already more assembly issue entries relating to the third step than any of the other steps of assembling the product.

The analysis to identify, at step 240, a deficiency in the assembly instructions may be based on trends. The analysis of trends may include flagging an assembly step with an accelerated reception of received assembly issues. For example, a received assembly issues related to a product may total 123 entries within the last month. Continuing the example, the product may have received 230 assembly entry issues within the previous six months. Further continuing the example, the analysis may identify the 123 entries as a deficiency in assembly instructions based on a rule of any increase over 40% within any given 45 days. The analysis to identify, at step 240, a deficiency in the assembly instructions may be based on one or more methods of detecting outliers (e.g., utilizing a standard deviation, etc.). In some embodiments, the analysis may include identification of common solutions (assistance feedback) that are provided to users in response to the assembly issues.

If a deficiency in assembly instructions is identified, at 242, a corrective action may be performed at 244. The corrective action may be an update to the data store, such as flagging one or more records in the database associated with the product, the assembly instructions of the product, the assembly step of the product, etc. The corrective action may be to notify the designer of the product to make an engineering change to simplify the assembly. The corrective action may be to notify one or more employees or agents of the deficiency in the assembly instructions. The notification may be in a format that identifies the deficiency in the assembly instructions. For example, a server that executes method 100 may have access to an email server also running on the server. Further in the example, the server may determine that a corrective action should be taken, and may generate and transmit an email to a documentation expert. Continuing the example, the documentation expert may receive the email and may discern from the email the product, the instructions, and the steps in the instructions that are lacking.

In some embodiments, the corrective action may be to enable an employee of the product provider to correct the assembly instructions. In detail, the server may perform the corrective action by utilizing one or more of the identified assembly deficiency, the received assembly step, and the received assembly issue. The server may further utilize the analysis done during identification of the deficiency in the assembly instructions, at 240. The server may utilize any analysis of the solutions that were performed during identification of the deficiency in the assembly instructions, at 240. For example, the assistance feedback for an assembly issue with step three of a given product may be as follows: thirty times additional instructions were displayed, forty times an audio-visual communication with an expert was initiated, twelve times a connection to a hyperlink social networking site was provided. Continuing the example, the server may retrieve the additional instructions that were provided as assistance feedback. The retrieved additional instructions for step three as well as the original instructions for step three may be send to an instruction writer. The server may also send the hyperlink to the social networking site to the instruction writer. Finalizing the example, the instruction writer may edit or remove any of the additional instructions that were sent to the server and may likewise determine whether to keep the hyperlink to the social networking site to step three. After the corrective action was provided at 244 (or if there was no identified deficiency at 242), method 100 ends at 295.

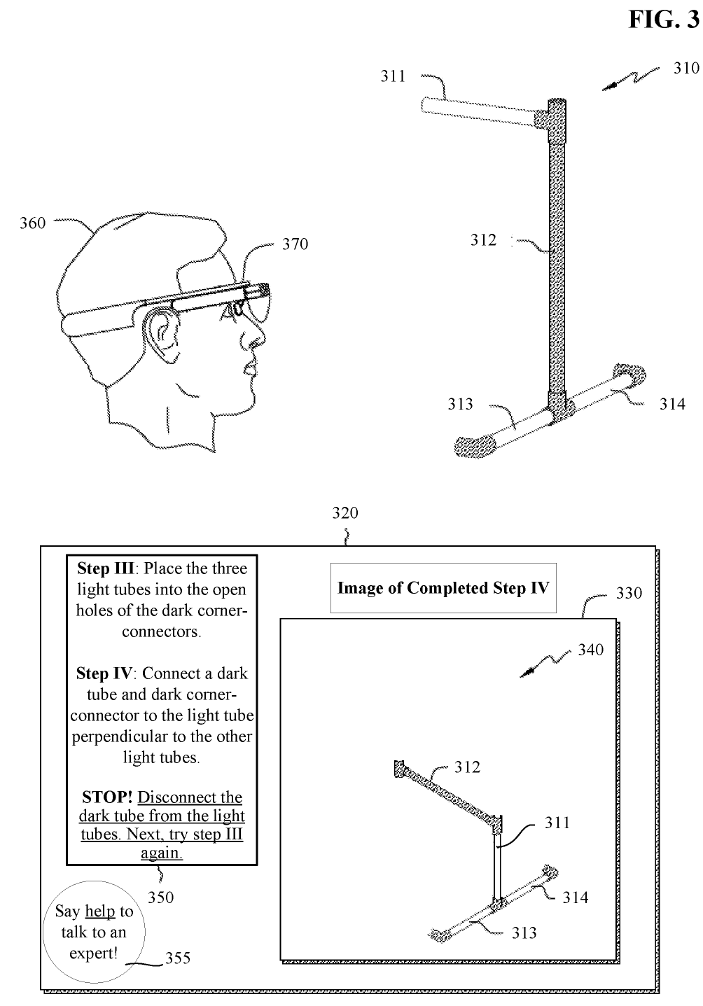

FIG. 3 depicts an example environment of a computing device 370 being used to provide assembly instructions and a feedback loop to assist a user 360 with assembly of a product in accordance with embodiments of the present disclosure. In this depicted example, a user 360 may be attempting to utilize device 370 to read instructions as he assembled the product. In this instance, the product is a stand for a drying laundry and the user 360 has connected some of the parts of the stand into a configuration of a partial assembly 310. As shown, the user's configuration of the partial assembly 310 of the stand includes two light tubes 313 and 314 connected together at the lower end of a dark tube 312. The top of the dark tube 312 is connected to a third light tube 311.

In order to analyze the partial assembly 310, the user 360 may first use a camera of his head-mounted wearable device 370 to capture a set of images of the partial assembly 310. More specifically, the user 360 may, in this example, use the camera to take several photos while moving around the partial assembly 310 in order to capture several different views of the partial assembly 310. In some embodiments, reference objects with known spatial dimensions may be included in the captured images. Next, the user 360 may communicate with the wearable device 370 about the captured images via a graphical user interface (GUI) 320 which may be displayed on the wearable device 370. In some embodiments, the GUI 320 may be provided as part of a mobile application specifically designed for use in assembling furniture.

Upon completion of the capturing of the captured images, the wearable device 370 may compare the captured images to a set of preloaded images of a correct configuration of a completed assembly step 340 of the stand. In the alternative (or in addition), the wearable device may generate a three-dimensional model of the partial assembly 310 and compare this model to a set of preloaded three-dimensional models of the completed assembly step 340.

The comparisons may rely on known image analysis techniques. Based on the results of the comparisons, the wearable device 370 may determine whether the user's configuration of the partial assembly 310 is correct. In the depicted example, the tubes 311 and 312 are, within the partial assembly 310, in incorrect locations relative to the parts 313 and 314. Thus, the wearable device may determine that a potential assembly issue with the user's partial assembly. Based on this determination, the wearable device 370 may notify the user 360 that the partial assembly 310 is incorrect via the GUI 320. Specifically, as depicted, the GUI 320 may show an image box 330 having an image or model of the correct configuration of the completed assembly step 340. The GUI 320 may also include a text box 350 with scrolling directions.

The GUI 320 may be modified to provide assistance feedback, in response to the app determining an issue with assembly of the laundry stand. The assistance feedback may include adjusting the text box 350 by inserting a warning composed of bold and underlined text. Additionally the assistance feedback may be an alert 355 that asks if the user 360 would like to begin a communication session with a product assembly expert. Armed with this knowledge and with the confidence of expert availability, the user 360 may then reconfigure the partial assembly 310 and then properly complete the assembly of the stand.

FIG. 4 depicts the representative major components of an example computer system 401 that may be used, in accordance with embodiments of the present disclosure. It is appreciated that individual components may vary in complexity, number, type, and\or configuration. The particular examples disclosed are for example purposes only and are not necessarily the only such variations. The computer system 401 may comprise a processor 410, memory 420, an input/output interface (herein I/O or I/O interface) 430, and a main bus 440. The main bus 440 may provide communication pathways for the other components of the computer system 401. In some embodiments, the main bus 440 may connect to other components such as a specialized digital signal processor (not depicted).

The processor 410 of the computer system 401 may be comprised of one or more cores 412A, 412B, 412C, 412D (collectively 412). The processor 410 may additionally include one or more memory buffers or caches (not depicted) that provide temporary storage of instructions and data for the cores 412. The cores 412 may perform instructions on input provided from the caches or from the memory 420 and output the result to caches or the memory. The cores 412 may be comprised of one or more circuits configured to perform one or methods consistent with embodiments of the present disclosure. In some embodiments, the computer system 401 may contain multiple processors 410. In some embodiments, the computer system 401 may be a single processor 410 with a singular core 412.

The memory 420 of the computer system 401 may include a memory controller 422. In some embodiments, the memory 420 may comprise a random-access semiconductor memory, storage device, or storage medium (either volatile or non-volatile) for storing data and programs. In some embodiments, the memory may be in the form of modules (e.g., dual in-line memory modules). The memory controller 422 may communicate with the processor 410, facilitating storage and retrieval of information in the memory 420. The memory controller 422 may communicate with the I/O interface 430, facilitating storage and retrieval of input or output in the memory 420.

The I/O interface 430 may comprise an I/O bus 450, a terminal interface 452, a storage interface 454, an I/O device interface 456, and a network interface 458. The I/O interface 430 may connect the main bus 440 to the I/O bus 450. The I/O interface 430 may direct instructions and data from the processor 410 and memory 420 to the various interfaces of the I/O bus 450. The I/O interface 430 may also direct instructions and data from the various interfaces of the I/O bus 450 to the processor 410 and memory 420. The various interfaces may include the terminal interface 452, the storage interface 454, the I/O device interface 456, and the network interface 458. In some embodiments, the various interfaces may include a subset of the aforementioned interfaces (e.g., an embedded computer system in an industrial application may not include the terminal interface 452 and the storage interface 454).

Logic modules throughout the computer system 401—including but not limited to the memory 420, the processor 410, and the I/O interface 430—may communicate failures and changes to one or more components to a hypervisor or operating system (not depicted). The hypervisor or the operating system may allocate the various resources available in the computer system 401 and track the location of data in memory 420 and of processes assigned to various cores 412. In embodiments that combine or rearrange elements, aspects and capabilities of the logic modules may be combined or redistributed. These variations would be apparent to one skilled in the art.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for aiding assembly of a product, the product comprising a plurality of parts, the method comprising:
obtaining a set of images of the product as the plurality of parts are being assembled, the set of images obtained from at least one camera;
detecting, based on the set of obtained images, an assembly step being performed;
retrieving one or more assembly metrics for assembling the product;
determining, based on the detected assembly step and based on the retrieved assembly metrics, a potential assembly issue; and
providing, based on the determined potential assembly issue, an assistance feedback.

2. The method of claim 1, wherein the set of images are a second set of images, and wherein the assembly step is a second assembly step and wherein the determining is further based on a first assembly step, the method further comprises:
obtaining a first set of images of the product as the plurality of parts are being assembled, the first set of images obtained before the second set of images are obtained; and
detecting, based on the first set of obtained images, a first assembly being completed, the first assembly step completed before the second assembly step.

3. The method of claim 2, wherein the one or more assembly metrics include the average time to perform the second assembly step, and wherein the potential assembly issue is performing the second assembly step in a time longer than the average time.

4. The method of claim 2, wherein the one or more assembly metrics indicate that the second assembly step should be completed before performing the first assembly step, and wherein the potential assembly issue is an out-of-order assembly.

5. The method of claim 1, wherein the one or more assembly metrics indicate the orientation of a first part in relation to a second part of the plurality of parts, and wherein the determined potential assembly issue is an improper orientation of the first part.

6. The method of claim 1, wherein the camera is communicatively coupled to a computing device.

7. The method of claim 6, wherein the computing device is selected from the group consisting of a smartphone, a headset, and a tablet.

8. The method of claim 6, wherein the computing device provides the assistance feedback.

9. The method of claim 1, wherein the set of images are obtained from at least two cameras.

10. The method of claim 1, wherein the assistance feedback is additional instructions.

11. The method of claim 1, wherein the assistance feedback is a link to a community-based online resource.

12. The method of claim 1, wherein the assistance feedback is an audio-visual demonstration.

13. The method of claim 1, wherein the assistance feedback is a communication session with an experienced assembler of the product.

14. The method of claim 1, wherein the method further comprises:
updating, based on the determined potential assembly issue and based on the detected assembly step, an assembly data store;
identifying, based on the determined potential assembly issue and based on the updated assembly data store, a deficient assembly instruction; and
performing, based on the identified deficient assembly instruction, a corrective action.

15. The method of claim 14, wherein the corrective action is updating the assembly instructions for the assembly step.

16. The method of claim 14, wherein the corrective action is notifying an assembly instruction preparer regarding the identified deficient assembly instruction.

17. A computing device for aiding assembly of a product, the product comprising a plurality of parts, the computing device comprising:
a memory;
a camera, the camera for capturing one or more images; and
a processor, the processor in communication with the memory and in communication with the camera, wherein the processor is configured to perform a method comprising:
obtaining, from the camera, a set of images of the product as the plurality of parts are being assembled;
detecting, based on the set of obtained images, an assembly step being performed;
retrieving one or more assembly metrics for assembling the product;
determining, based on the detected assembly step and based on the retrieved assembly metrics, a potential assembly issue; and
providing, based on the determined potential assembly issue, an assistance feedback.

18. The computing device of claim 17, wherein the assistance feedback is an audio-visual demonstration.

19. A computer program product for aiding assembly of a product, the product comprising a plurality of parts, the computer program product comprising a computer readable storage medium having program instructions embodied therewith, the program instructions executable by a computer to perform a method comprising:
obtaining a set of images of the product as the plurality of parts are being assembled, the set of images obtained from at least one camera;
detecting, based on the set of obtained images, an assembly step being performed;
retrieving one or more assembly metrics for assembling the product;
determining, based on the detected assembly step and based on the retrieved assembly metrics, a potential assembly issue; and
providing, based on the determined potential assembly issue, an assistance feedback.

20. The computer program product of claim 19, wherein the one or more assembly metrics indicate the orientation of a first part in relation to a second part of the plurality of parts, and wherein the determined potential assembly issue is an improper orientation of the first part.
